(19) United States
(12) Patent Application Publication
(10) Pub. No.: US 2012/0136703 A1
(43) Pub. Date: May 31, 2012

(54) METHOD AND SYSTEM FOR ORGANIZING REFERRALS

(76) Inventor: John Stewart, Roseneath (CA)

(21) Appl. No.: 12/956,053

(22) Filed: Nov. 30, 2010

(51) Int. Cl. G06Q 30/00

(52) U.S. Cl. 705/14.16

(57) ABSTRACT

A method and system for organizing referrals from at least one referrer to at least one referee for the purchase of products sold by merchants. The present invention further provides that referrers are compensated when a referee buys a specific product from a specific merchant that was referred to the referee by the referrer. Referrers and merchants, and optionally referees, are able to register with an online site to create a unique profile. For merchants, the unique profile will enable merchants to track products that are referable. For referrers, the unique profile will enable them to track which products they have referred to one or more referees.

### FIELD OF THE INVENTION

Embodiments of the invention relates to computer-implemented methods and systems for organizing referrals for the purchase of goods or services sold by various merchants.

### BACKGROUND OF THE INVENTION

Today, word of mouth is one of the most important and powerful referral catalysts that merchants rely on for sales.

Referrals, i.e., word of mouth, are the life-blood for most small businesses. Millions of people casually vouch for a business or a service everyday to their friends.

In a recent survey, over 7000 business respondents indicated that marketing is one of the areas where they need the most help. This survey also indicated that despite the growing popularity of online marketing technologies, e-mail marketing is still more popular than online advertising. Furthermore, the respondents were asked, “How important to your business is each of the following methods in finding new customers or members?” There were ten categories to choose from. Word of mouth was considered the most important, with a website and an e-mail marketing strategy in second and third place, respectively.

Therefore, there is a need to enable merchants to encourage and track word of mouth referrals for the goods and/or services that they sell.

### SUMMARY OF INVENTION

Embodiments of the invention is a method and system for organizing referrals from at least one referrer to at least one referee for the purchase of products sold by merchants. The present invention further provides that referrers are compensated when a referee buys a specific product from a specific merchant that was referred to the referee by the referrer. Referrers and merchants, and optionally referees, are able to register with an online site to create a unique profile.

For merchants, the unique profile will enable merchants to track products that are referable. For referrers, the unique profile will enable them to track which products they have referred to one or more referees.

Embodiments of the invention provides a computer-implemented method for structuring a referral from a referrer to a referee to buy a product being sold by a merchant that includes at least one of the following: (a) based on input from the merchant, generating a referral option for the product sold by the merchant to be viewed by the referrer; (b) based on input from the referrer, sending a first electronic notification to the referee to notify the referee of the referral option; (c) generating a unique identification (ID) to associate with the first referral notification and storing the unique ID with its associated referral notification; (d) if the first referral notification is acted upon and the product is purchased by the referee, converting the unique ID into an action item; and then, (e) providing the referrer with a first commission for the sale of the product.

Embodiments of the invention provides a computer-implemented system for structuring a referral from a referrer to a referee to buy a product being sold by a merchant comprising: at least one user interface component having a merchant interface to generate a referral option based on merchant input for viewing by the referrer, and further having a consumer interface with the referrer and the referee; a server having an electronic communication mechanism constructed and arranged to communicate with the merchant, the referrer, and the referee, and constructed and arranged to send an electronic notification to the referee to notify the referee of the referral option and to notify the referrer of a commission from the merchant once the referral notification is acted upon; and the server having a processing and storage mechanism for generating a unique identification (ID) to associate with the notification, for storing the unique ID with its associated referral notification, and for converting the unique ID into an action item if the referral notification is acted upon by the referee.

Embodiments of the invention provides a computer-implemented system for structuring a referral from a referrer to a referee to buy a product being sold by a merchant comprising: a server having an electronic communication mechanism constructed and arranged to communicate with the merchant, the referrer, and the referee, and having an electronic communication mechanism for communication between the merchant, the referrer, and the referee, and constructed and arranged to send an electronic notification to the referee to notify the referee of the referral option and to notify the referrer of a commission from the merchant once the referral notification is acted upon; and the server having a processing and storage mechanism for generating a unique identification (ID) to associate with the notification, for storing the unique ID with its associated referral notification, and for converting the unique ID into an action item if the referral notification is acted upon by the referee.

### BRIEF DESCRIPTION OF THE DRAWINGS

Embodiments of the invention will now be described by reference to the following figures, in which identical reference numerals in different figures indicate identical elements and in which:

FIG. 1 illustrates a block diagram of a computer-implemented system in accordance with embodiments.

FIG. 2 illustrates a block diagram of a computer-implemented system in accordance with embodiments.

FIG. 3 illustrates a flowchart of a computer-implemented method in accordance with embodiments.

FIG. 4 illustrates a screenshot of an exemplary merchant and consumer user interface in accordance with embodiments.

FIG. 5 illustrates a screenshot of an exemplary consumer user interface in accordance with embodiments.

FIG. 6 illustrates a screenshot of an exemplary merchant user interface in accordance with embodiments.

FIG. 7 illustrates a screenshot of an exemplary consumer user interface for a handheld device in accordance with embodiments.

### DETAILED DESCRIPTION OF THE INVENTION

This document defines a product as any good or service that a merchant may offer for sale to a consumer.

This document defines a merchant as a registered system user that offers a product for sale that can be referred for sale through the system and method of the present invention.

This document also defines a referrer as a registered system user that may be a consumer or a merchant. It should be mentioned that a merchant may be registered as a merchant and as a referee, i.e., a merchant can also be a referrer that refers a product of another merchant to a referee.

This document defines a referee as a system user, registered or not registered, that purchases a product referred to the referee by the referrer.

It should also be understood that the present invention may be implemented using a private or a public network. For example, the system may be online and accessible through the Internet.

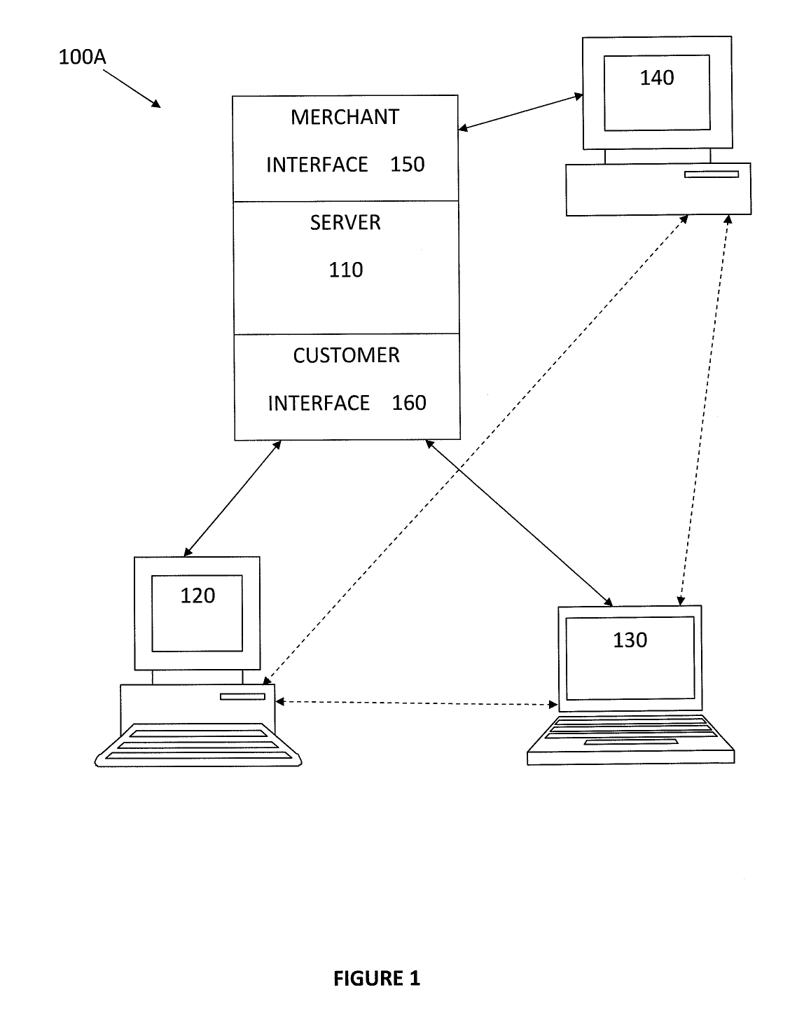

FIG. 1 is a block diagram of a computer-implemented system in accordance with embodiments of the invention. The exemplary system 100A comprises a server 110, having internal processing means, memory means, and communication means (not shown). The server 110 also includes at least one user interface component enabling a merchant interface 150 and a consumer interface 160. Through the server's communication means, the server 110 is in communication with the referrer 120, the referee 130, and the merchant 140, as illustrated through the connecting lines.

The merchant interface 150 and the consumer interface 160 may be a combined user interface or two distinct interfaces. For example, the referrer 120 and the merchant 140 may access the same user interface. However, each registered user—merchant or referrer—will have its own individualized profile and user interface page.

As illustrated in FIG. 1, the referrer 120 and referee 130 communicate with the server 110 through the consumer interface 160, enabled by the at least one consumer interface component (not shown). The merchant 140 communicates with the server through the merchant interface 150, also enabled by at least one consumer interface component (not shown).

It should be mentioned that a plurality of merchants, referrers, and referees are contemplated by the present invention, and that the server 110 may be in communication with each of the pluralities. However, for visual simplicity, only one referrer 120, one merchant 140, and one referee 130 are shown.

It should also be mentioned that the user interface components may not be required in accordance with another embodiment of the invention. Alternative interfacing with the system and between its users may be contemplated. For example, short message services (SMSs) or electronic mail (e-mail) may be used to communicate referral-related information between all of the users and the system.

In FIG. 1, the dashed lines between the referrer 120 and the referee 130 represent an optional communication means and channel between the referrer 120 and the referee 130. The referrer 120 and the referee 130 may be in direct contact about the referral system. For example, the referrer 120 may send an e-mail notification directly to the referee 130 about a referral that the referee 130 may be interested in. This is in contrast to the notification being sent through the communication means of the server 110. The referrer 120 may also utilize the communication channel to encourage the referee 130 to register as a user of the system.

In addition, the dashed lines between the merchant 140 and the referrer 120 and the referee 130, respectively, represent an optional communication means and channel between the merchant 140 and the referrer 120 and the referee 130, respectively. Through this additional communication channel, the merchant 140 may encourage the referee to join as a registered user of the system. The merchant 140 may also utilize the communication channel to coordinate payment of a commission to the referrer 120 once the referee 130 has purchased the referred product.

It should also be mentioned that registration as a system user, by a merchant 140, a referrer 120, or a referee 130, may be free or a paid subscription. The system server 110 administers the registration.

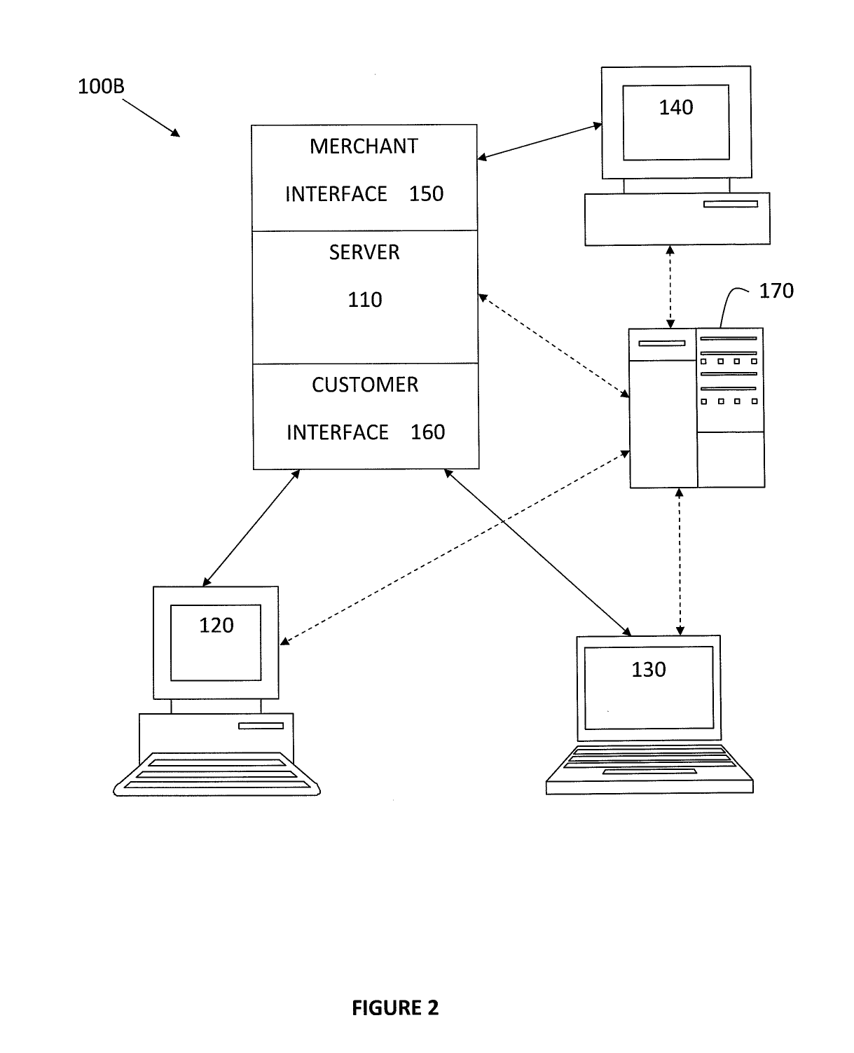

FIG. 2 illustrates a block diagram of another exemplary system 100B in accordance with embodiments of the invention. Here, a third party payment means 170 is further included as part of the system 100B. The dashed lines represent communication means and channels between the third party payment means 170 and the server 110, the referrer 120, the referee 130, and the merchant 140, respectively. Once a referral notification has been acted upon, the server 110 or the merchant 140 can notify the third party payment means 170 that a commission is payable. Depending on what the merchant 140 decided, a commission may be payable to either or both the referrer 120 and the referee 130. The merchant 140 is in communication with third party payment means 170 to coordinate the payment of the commission, including any monetary transfer that is required. Upon receipt of the commission payment, the third party payment means 170 is in communication with the referrer 120 and possibly the referee 130 as well, to pay the commission(s).

Embodiments of the invention contemplates that commission compensation will be in the form of money or in any other form that has a monetary value, such as coupons or points that can be used towards the purchase of something from a specific merchant.

In accordance with embodiments, the merchant 140 is able to set a commission amount based on the product type or a flat-fee basis. The commission paid may also be a percentage of the total value of the product sold.

Alternatively, embodiments of the invention also contemplates that a minimum balance in a cash value will be needed before a transfer is made to a referrer and/or referee.

Embodiments of the invention also contemplates withholding a percentage of the commission or having a flat-fee paid to the system operator to generate a revenue stream for the system.

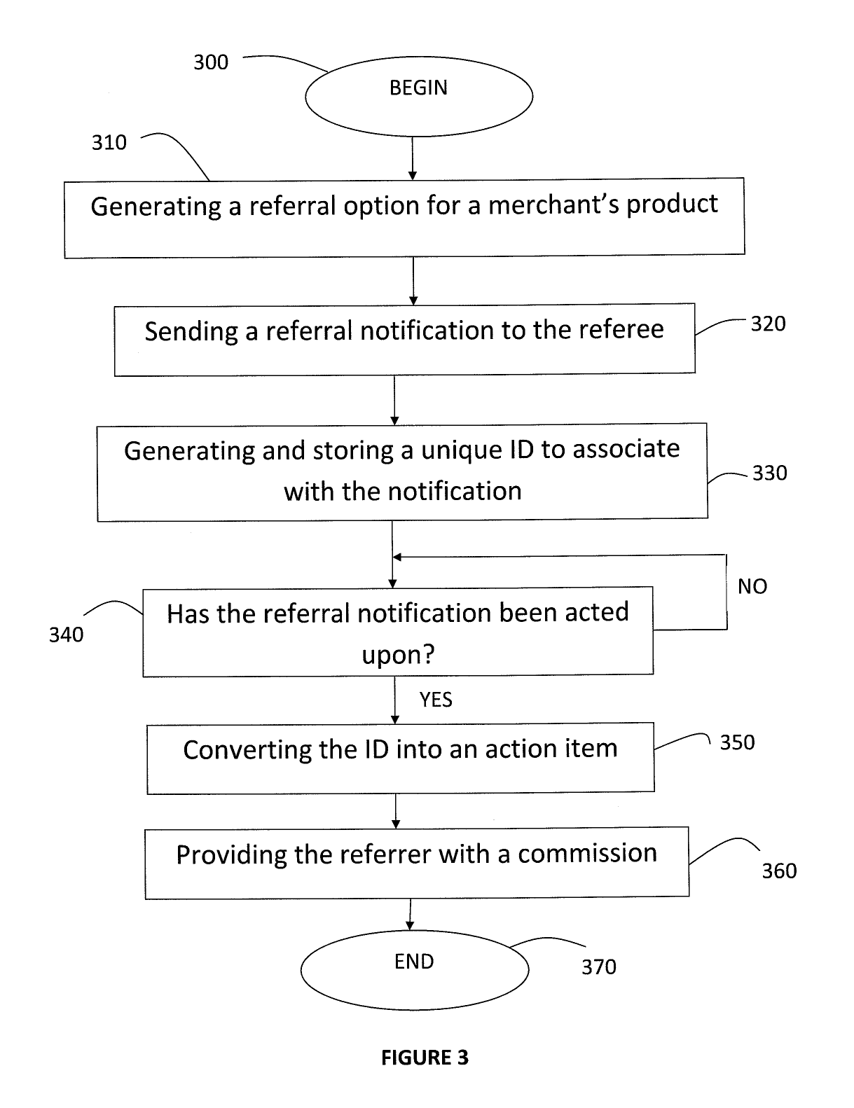

FIG. 3 illustrates a flowchart of a computer-implemented in accordance with embodiments of the invention. The method begins at step 300. Next, at 310, the method generates a referral option for the product by the merchant based on input from the merchant. Here, the merchant input will include at least one product as a referral option that the merchant would like referrers to refer to other referees. The merchant will also indicate what the commission, if any, should be for a successful referral (i.e., has the referee bought the product?).

Embodiments of the invention also contemplates that the referral option may be dynamic. In other words, the merchant can alter the terms of the referral option and its corresponding commission. Embodiments of the invention also contemplates that once a referral option has been posted, a referrer can view the referral option.

Referring again to FIG. 3, the next step is step 320. Here, a first electronic notification is sent to the referee to notify the referee of the referral option based on input from the referrer. The referrer input will include which referee(s) to notify about the referral option. As may be readily understood by the skilled artisan, embodiments of the invention contemplates that the referrer may refer the same product to more than one referee. Next, the method performs step 330, and generates a unique identification (ID) to associate with the notification. In step 330, the unique ID is stored with its associated referral notification.

Following step 330, step 340 is executed. Here, the process queries whether the referral notification has been acted upon, i.e., has the product been purchased by the referee. If the answer is yes, the process follows step 350. If the answer is no, the process loops back to step 340 and awaits an affirmative determination on that referral notification. In step 350, the unique ID is converted into an action item to issue whatever commission has been associated with the referral option. Following step 350, step 360 is executed. In step 360, a commission is provided to the referrer for the sale of the product. As mentioned previously, step 360 also contemplates that the referee may be paid a commission, in addition to one being paid to the referrer.

Embodiments of the invention also contemplates that the merchant may decide to pay a commission only to the referee. In other words, the referrer does not make a commission on the referral option.

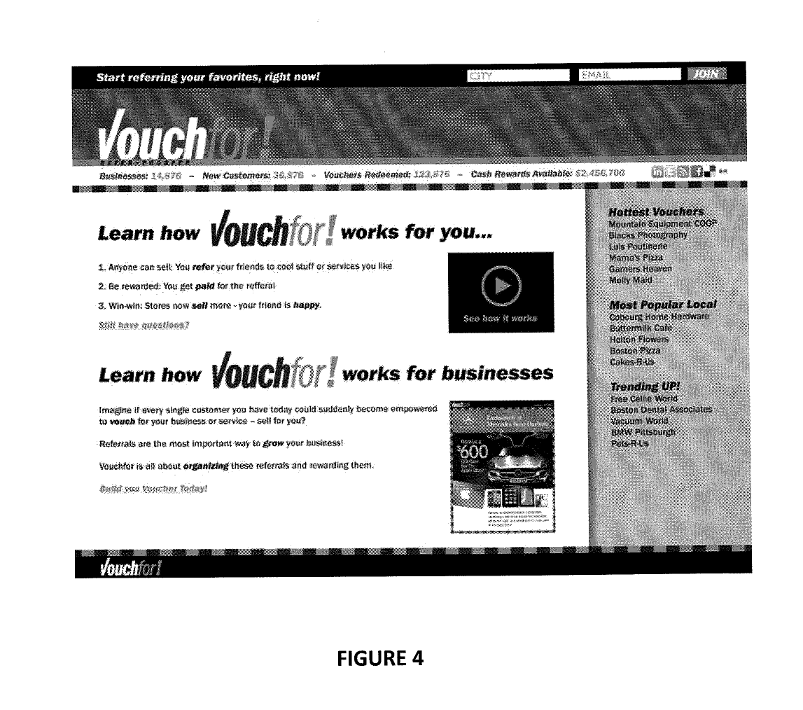

FIG. 4 illustrates a screenshot of an exemplary merchant and consumer user interface in accordance with embodiments of the invention. Here, the user interface enables both referrers and merchants to join the online system.

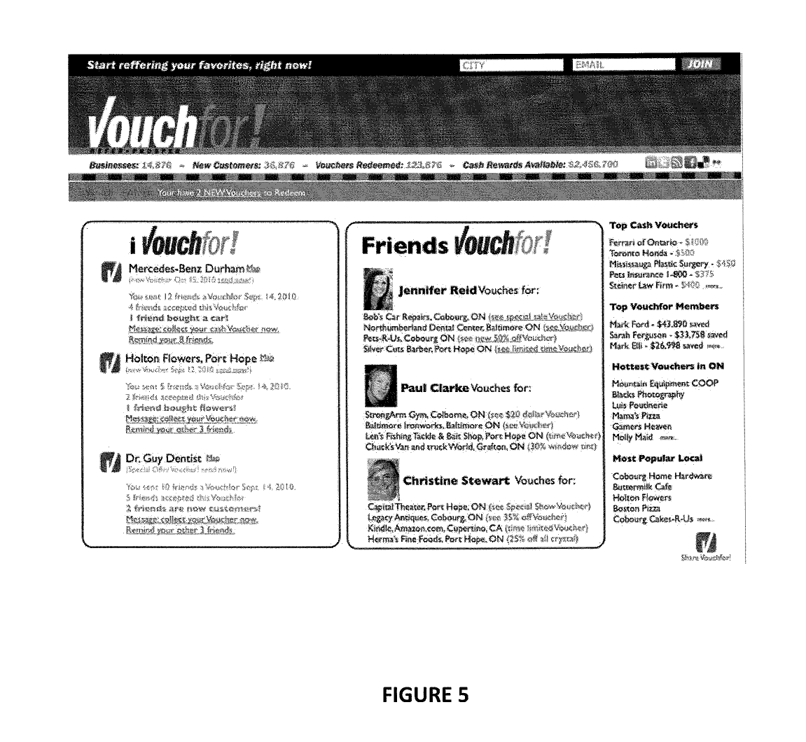

FIG. 5 illustrates a screenshot of an exemplary consumer user interface in accordance with embodiments of the invention. Here, an individualized and online interface page is shown for a registered referrer. The page includes a listing of all of the referrals made by the referrer. The page also indicates that the referrer may want to remind some referees of the referrals by sending notifications. In accordance with embodiments of the invention, the referrer can request that further notifications be sent to the referees as a reminder that the referral has not been acted upon.

The referrer can also have registered friends and be linked to those friends that are also system users. Here, the referrer has three (3) friends that have each referred several products. A listing of those products is provided. These friend listings may encourage the referrer to refer the same products as his or her friends. The page also includes are listing of the top referral options (referred to in the page as a “voucher”).

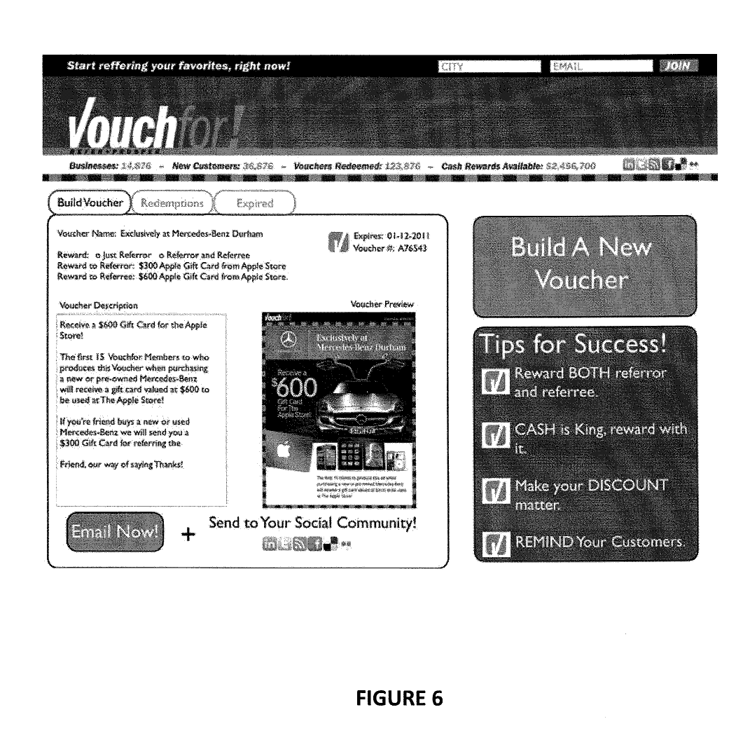

FIG. 6 illustrates a screenshot of an exemplary merchant user interface in accordance with embodiments of the invention. Here, the merchant is providing input for a referral option (referred to in the page as a “voucher”). The product that the merchant is offering for referral option is a vehicle. The merchant has also indicated that he will pay a commission in the form of a $300 gift card to the referrer and a $600 gift card to the referee.

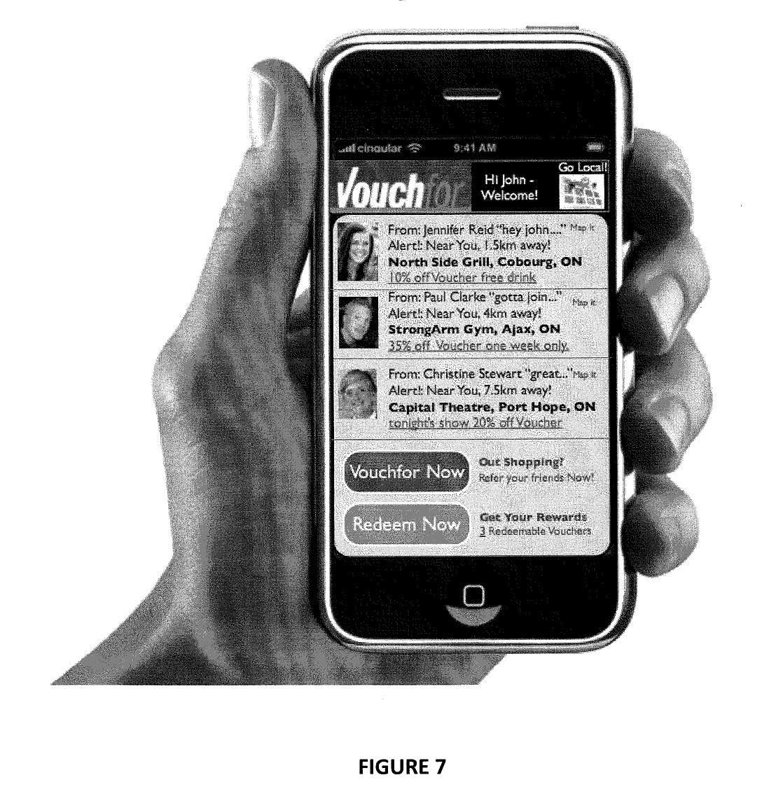

FIG. 7 illustrates a screenshot of an exemplary consumer user interface for a handheld device in accordance with embodiments of the invention. As will be readily understood by the skilled artisan, embodiments of the invention contemplates many different user interfaces for many different devices. For example, a user interface constructed and arranged for a mobile tablet computing device is also contemplated.

Using location based contextual information is also contemplated in accordance with embodiments of the invention. Here, any user of the system—a referrer, a referee, or a merchant—can view referral options that are geographically targeted to the exact location of their mobile device. This geographic targeting allows for proximity-based sorting and reviewing by a system user on a wireless device. Certain triggers or alerts may also be launched by the system and method that announce the availability of a referral or of a referring merchant whose physical store location is proximate to the mobile device.

The method steps in accordance with embodiments of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

Embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A computer-implemented method for structuring a referral from a referrer to a referee to buy a product being sold by a merchant, the computer-implemented method comprising:
(a) generating a referral option for the product sold by the merchant to be viewed by the referrer based on input from the merchant;
(b) sending a first electronic notification to the referee to notify the referee of the referral option based on input from the referrer;
(c) generating a unique identification (ID) to associate with the first referral notification and storing the unique ID with its associated referral notification;
(d) converting the unique ID into an action item if the first referral notification is acted upon and the product is purchased by the referee; and then
(e) providing the referrer with a first commission for the sale of the product.

2. The method of claim 1, wherein the first electronic notification in step (b) is sent indirectly to the referrer by the referee through a user interface component.

3. The method of claim 1, wherein step (e) includes the merchant providing the referrer with the first commission through a third party payment means.

4. The method of claim 1, wherein step (e) includes the merchant providing the referee with a second commission.

5. The method of claim 4, wherein step (e) further includes the merchant providing the referee with the second commission through a third party payment means.

6. The method of claim 1, further comprising, after executing step (c) and prior to executing step (d):
sending a second electronic notification to the referee to remind the referee of the first referral notification, if the referrer is awaiting the referee to purchase the product, based on referrer input.

7. The method of claim 1, further comprising, prior to executing step (a):
registering said merchant as a user of an online site, and creating a unique account for the merchant to track any referral options that are generated.

8. The method of claim 1, further comprising, prior to executing step (b):
registering said referrer as a user of an online site, and creating a unique account for the referrer to track any referral options that are sent.

9. The method of claim 1, wherein the referral option is at least one referral option.

10. The method of claim 1, wherein the referrer is at least one referrer.

11. The method of claim 1, wherein the referee is at least one referee.

12. The method of claim 1, wherein the merchant is at least one merchant.

13. The method of claim 1, wherein the product is one of a good or service.

14. The method of claim 1, wherein the referee is paid the commission instead of the referrer.

15. A computer-implemented system for structuring a referral from a referrer to a referee to buy a product being sold by a merchant, the computer-implemented system comprising:
at least one user interface component having a merchant interface to generate a referral option based on merchant input for viewing by the referrer, and further having a consumer interface with the referrer and the referee; and
a server having electronic communication means constructed and arranged to communicate with the merchant, the referrer, and the referee, and constructed and arranged to send an electronic notification to the referee to notify the referee of the referral option and to notify the referrer of a commission from the merchant once the referral notification is acted upon,
wherein the server has processing and storage means for generating a unique identification (ID) to associate with the notification, for storing the unique ID with its associated referral notification, and for converting the unique ID into an action item if the referral notification is acted upon by the referee.

16. The computer-implemented system of claim 15, wherein the at least one user interface component is two separate components constructed and arranged to provide a unique merchant interface for the merchant and a unique consumer interface for the referrer and the referee.

17. The computer-implemented system of claim 15, wherein the referee is a plurality of referees, and wherein the electronic communication means is in communication with each of the plurality of referees.

18. The computer-implemented system of claim 15, wherein the merchant is a plurality of merchants, and the electronic communication means is in communication with each of the plurality of merchants.

19. The computer-implemented system of claim 15, wherein the referee is a plurality of referees, and wherein the electronic communication means is in communication with each of the plurality of merchants.

20. The computer-implemented system of claim 15, further including an additional communication channel between the referrer and the referee, wherein the additional communication channel is constructed and arranged to enable the referrer to send an electronic notification to the referee to notify the referee of the referral option.

21. A computer-implemented system for structuring a referral from a referrer to a referee to buy a product being sold by a merchant, the computer-implemented system comprising:
a server having electronic communication means constructed and arranged to communicate with the merchant, the referrer, and the referee, the electronic communication means arranged to also permit communication between the merchant, the referrer, and the referee, and to send an electronic notification to the referee to notify the referee of the referral option and to notify the referrer of a commission from the merchant once the referral notification is acted upon,
wherein the server has processing and storage means for generating a unique identification (ID) to associate with the notification, for storing the unique ID with its associated referral notification, and for converting the unique ID into an action item if the referral notification is acted upon by the referee.
